(19) United States
(12) Patent Application Publication
(10) Pub. No.: US 2010/0293582 A1
(43) Pub. Date: Nov. 18, 2010

(54) REPRODUCING APPARATUS

(75) Inventor: Yoshihide Takahashi, Kyotanabe City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 12/775,740

(22) Filed: May 7, 2010

(30) Foreign Application Priority Data
May 8, 2009 (JP) 2009-113329

(51) Int. Cl. H04N 5/91

(52) U.S. Cl. 725/100; 386/E05.003

(57) ABSTRACT

A reproducing apparatus includes a signal processing unit which generates and transmits reproduction data, a reproduction unit which receives and reproduces the reproduction data, and a remote controller which inputs an instruction signal to the reproduction unit. The reproduction unit inputs a locater signal to the signal processing unit, and the signal processing unit operates based on the locater signal. In particular, the signal processing unit controls to enable or disable power supply for operation based on the locater signal.

### CROSS-REFERENCE TO RELATED APPLICATIONS

This application is based on Japanese Patent Application No. 2009-113329 filed on May 8, 2009.

### BACKGROUND OF THE INVENTION

1. Field of the Invention

The present invention relates to a reproducing apparatus including a signal processing unit which generates reproduction data by receiving a broadcasting signal or the like and transmits the reproduction data, and a reproduction unit which receives the reproduction data and reproduces the same.

2. Description of Related Art

Recent years, reproducing apparatuses for reproducing video and sound by receiving a broadcasting signal or the like are widely spread. As such a reproducing apparatus, there is one in which a signal processing unit such as a set top box (STB) for performing signal processing on the obtained broadcasting signal or the like so as to obtain data to reproduce and a reproduction unit such as a display device for reproducing data obtained in the signal processing unit are disposed separately from each other. This type of reproducing apparatus performs communication of reproduction data between the signal processing unit and the reproduction unit by using a high definition multimedia interface (HDMI) cable, wireless communication or the like.

In addition, there is particularly proposed a reproducing apparatus which includes a common remote controller that is capable of transmitting instruction signals for the signal processing unit and the reproduction unit, and a reception unit for receiving the instruction signal transmitted from the remote controller is provided only to the reproduction unit so that a simple configuration and improvement of operability are realized.

With reference to FIG. 7, a configuration of the above-mentioned reproducing apparatus will be described. FIG. 7 is a block diagram illustrating a configuration of a conventional reproducing apparatus. As illustrated in FIG. 7, a reproducing apparatus 100 includes a signal processing unit 110 which receives a broadcasting signal so as to generate reproduction data, a reproduction unit 130 which obtains the reproduction data from the signal processing unit 110 so as to reproduce the same, an HDMI cable 150 for connecting the signal processing unit 110 with the reproduction unit 130, and a remote controller 170 for inputting the instruction signal to the reproduction unit 130.

The signal processing unit 110 includes a broadcasting reception antenna 111 which receives a broadcasting signal, a tuner 112 which performs tuning and frequency conversion of the broadcasting signal received by the broadcasting reception antenna 111, a decoder 113 which demodulates and decodes the signal obtained by the tuner 112 to as to generate reproduction data, an HDMI transmission unit 114 which transmits the reproduction data generated by the decoder 113 to the reproduction unit 130 through the HDMI cable 150, a signal processing unit wireless communication unit 115 which encodes and modulates the reproduction data generated by the decoder 113 so as to generate a wireless signal, a signal processing unit antenna 116 which transmits the wireless signal generated by the signal processing unit wireless communication unit 115, a signal processing unit control unit 117 which controls an operation of the signal processing unit 110, a power supply operating unit 118 to which user's instruction is input about enabling or disabling power supply (ON or OFF) for the operation of the signal processing unit 110, and a signal processing unit power supply unit 119 which is controlled by the signal processing unit control unit 117 so as to supply power for the operation of the signal processing unit 110.

In addition, the reproduction unit 130 includes an HDMI reception unit 131 which receives the reproduction data sent through the HDMI cable 150, a reproduction unit antenna 132 which receives a wireless signal transmitted from the signal processing unit antenna 116, a reproduction unit wireless communication unit 133 which demodulates and decodes the wireless signal received by the reproduction unit antenna 132 so as to generate the reproduction data, a reproduction unit control unit 134 which controls an operation of the reproduction unit 130, a selector 135 which is controlled by the reproduction unit control unit 134 so as to select reproduction data output from either the HDMI reception unit 131 or the reproduction unit wireless communication unit 133 so as to output the selected data, an OSD data generation unit 136 which generates on screen display (OSD) data based on an instruction from the reproduction unit control unit 134, a display adjustment unit 137 which adjusts a size of video data contained in the reproduction data output from the selector 135 and superimposes the OSD data output from the OSD data generation unit 136 on the video data, a display panel 138 which displays the video data output from the display adjustment unit 137, a remote controller reception unit 139 which receives an instruction signal output from the remote controller 170 so as to outputs the same to the reproduction unit control unit 134, a reproduction unit power supply unit 140 which is controlled by the reproduction unit control unit 134 so as to supply power for an operation of the reproduction unit 130.

If the signal processing unit 110 is connected with the reproduction unit 130 through the HDMI cable 150, the reproduction unit control unit 134 supplies a consumer electronics control (CEC) signal to the signal processing unit 110 via the HDMI cable 150, so that an instruction input from the remote controller 170 to the reproduction unit 130 can be transmitted to the signal processing unit 110. Thus, for example, when an instruction signal to turn on the power supply for the operation of the signal processing unit 110 is issued from the remote controller 170 to the reproduction unit 130, the instruction can be transmitted to the signal processing unit 110 so that the power supply for the operation of the signal processing unit 110 can be turned on.

In addition, it is possible to adopt a configuration where the HDMI cable 150 is not used for enhancing flexibility in arranging the signal processing unit 110 and the reproduction unit 130. In this case, an instruction input from the remote controller 170 to the reproduction unit 130 is transmitted to the signal processing unit 110 via wireless communication so that the instruction can be transmitted in the same manner as the above-mentioned case of using the HDMI cable 150.

Specifically, for example, the reproduction unit wireless communication unit 133, the reproduction unit antenna 132, the signal processing unit antenna 116 and the signal processing unit wireless communication unit 115 are used for transmitting the signal so that the instruction is transmitted in the direction opposite to the direction in which the wireless signal is transmitted. In particular, when the signal processing unit 110 transmits the wireless signal to the reproduction unit 130, the configuration for transmitting an acknowledgement (ACK) signal and a retransmission request signal from the reproduction unit 130 to the signal processing unit 110 is utilized so that the instruction can be transmitted from the reproduction unit 130 to the signal processing unit 110.

However, the signal processing unit wireless communication unit 115 and the reproduction unit wireless communication unit 133 that are used for wireless communication of reproduction data that can be a large quantity of data consume large amount of power. Therefore, there is a problem that they consume large amount of power even in the standby state with power supplied. In particular, if a configuration is adopted in which the remote controller 170 sends an instruction of enabling or disabling not only the power supply for the reproduction unit 130 but also the power supply for the operation of the signal processing unit 110, it is necessary to continue to supply power the signal processing unit wireless communication unit 115 and the reproduction unit wireless communication unit 133 to be in the standby state even if the power supply for the operations of the signal processing unit 110 and the reproduction unit 130 is turned off. Thus, there is a problem of consuming the power wastefully.

In contrast, if a configuration is adopted in which the power supply for the operation of the signal processing unit 110 is enabled or disabled only by the power supply operating unit 118 (e.g., an operating button or key) and cannot be operated by the remote controller 170, the above-mentioned problem does not occur. However, this configuration causes a remarkable deterioration in operability of the reproducing apparatus 100.

### SUMMARY OF THE INVENTION

A reproducing apparatus of the present includes:

a signal processing unit which generates reproduction data;

a reproduction unit which reproduces the reproduction data;

a first wireless communication unit which performs wireless transmission of a wireless signal containing the reproduction data from the signal processing unit to the reproduction unit; and

a second wireless communication unit which performs wireless transmission of a control signal from one of the reproduction unit and the signal processing unit to the other, in which

the reproduction unit or the signal processing unit operates based on the control signal that is received.

### BRIEF DESCRIPTION OF THE DRAWINGS

FIG. 1 is a block diagram illustrating a configuration of a reproducing apparatus according to an embodiment of the present invention.

FIG. 2 is a flowchart illustrating an operation of the reproducing apparatus according to the embodiment of the present invention, which illustrates an operation of a reproduction unit.

FIG. 3 is a flowchart illustrating an operation of the reproducing apparatus according to the embodiment of the present invention, which illustrates an operation of a signal processing unit.

FIG. 4 is a timing chart illustrating an example of a pattern of a locater signal for turning on power supply for the operation of the signal processing unit.

FIG. 5 is a timing chart illustrating an example of a pattern of the locater signal for turning off power supply for the operation of the signal processing unit.

FIG. 6 is a timing chart illustrating an example of the pattern of the locater signal for the remote controller to perform an informing operation.

FIG. 7 is a block diagram illustrating a configuration of a conventional reproducing apparatus.

### DETAILED DESCRIPTION OF THE PREFERRED EMBODIMENTS

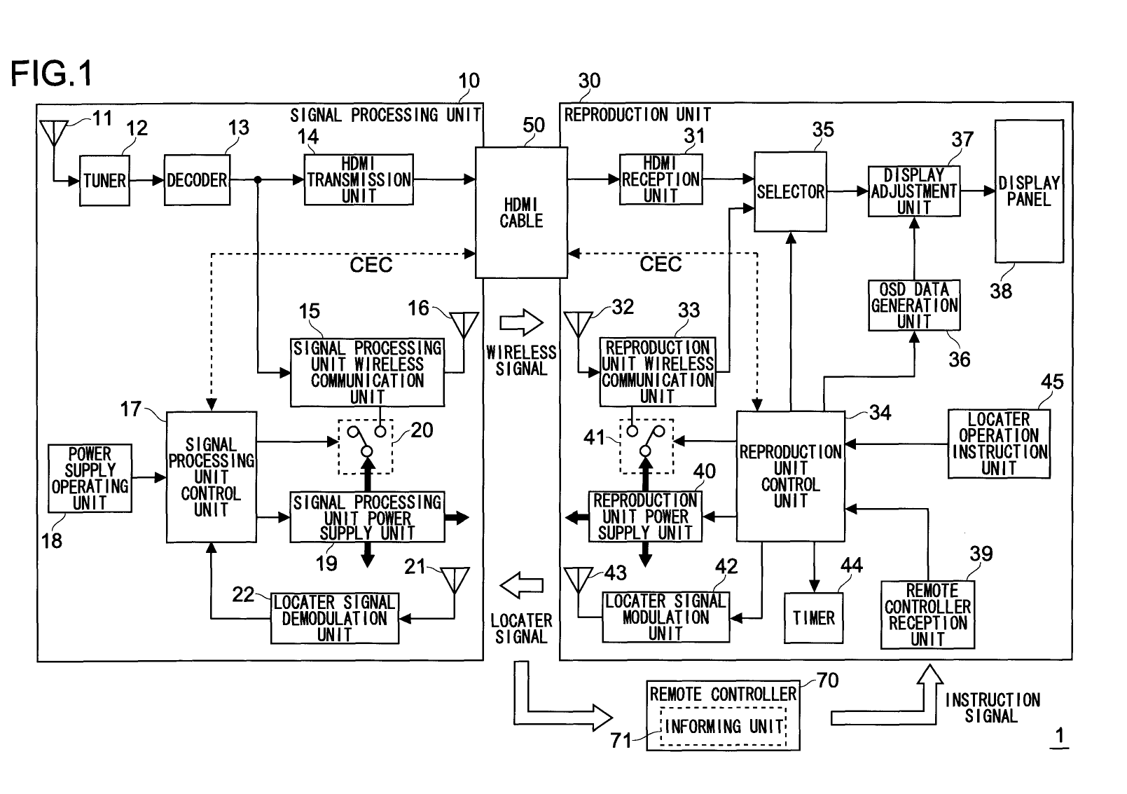

First, a configuration of a reproducing apparatus according to an embodiment of the present invention and operations of individual units will be described with reference to FIG. 1. FIG. 1 is a block diagram illustrating a configuration of the reproducing apparatus according to the embodiment of the present invention.

<Configuration of Reproducing Apparatus>

As illustrated in FIG. 1, the reproducing apparatus 1 includes a signal processing unit 10 which receives a broadcasting signal and generates reproduction data so as to transmit the same, a reproduction unit 30 which receives the reproduction data so as to reproduce the same, an HDMI cable 50 which connects the signal processing unit 10 with the reproduction unit 30, and a remote controller 70 which inputs an instruction signal to the reproduction unit 30.

The signal processing unit 10 includes a broadcasting reception antenna 11 which receives a broadcasting signal, a tuner 12 which performs tuning, frequency conversion and the like of the broadcasting signal received by the broadcasting reception antenna 11, a decoder 13 which demodulates and decodes the signal obtained in the tuner 12 so as to generate reproduction data, an HDMI transmission unit 14 which transmits the reproduction data generated by the decoder 13 to the reproduction unit 30 via the HDMI cable 50, a signal processing unit wireless communication unit 15 which encodes and modulates the reproduction data generated by the decoder 13 so as to generate a wireless signal, a signal processing unit antenna 16 which transmits the wireless signal generated by the signal processing unit wireless communication unit 15, a signal processing unit control unit 17 which controls an operation of the signal processing unit 10, a power supply operating unit 18 to which a user's instruction is input about enabling or disabling (turning on or off) power supply for the operation of the signal processing unit 10, and a signal processing unit power supply unit 19 which is controlled by the signal processing unit control unit 17 to supply power for the operation of the signal processing unit 10.

In addition, the signal processing unit 10 further includes a signal processing unit power switching unit 20 which is controlled by the signal processing unit control unit 17 so as to switch whether or not the power for operation from the signal processing unit power supply unit 19 is to be supplied to the signal processing unit wireless communication unit 15, a locater signal reception antenna 21 which receives a locater signal transmitted from a reproduction unit 30, and a locater signal demodulation unit 22 which demodulates a locater signal received by the locater signal reception antenna 21 so as to input the demodulated signal to the signal processing unit control unit 17.

In addition, the reproduction unit 30 includes an HDMI reception unit 31 which receives the reproduction data transmitted via the HDMI cable 50, a reproduction unit antenna 32 which receives a wireless signal transmitted from the signal processing unit antenna 16, a reproduction unit wireless communication unit 33 which demodulates and decodes the wireless signal received by the reproduction unit antenna 32 so as to generate reproduction data, a reproduction unit control unit 34 which controls an operation of the reproduction unit 30, a selector 35 which is controlled by the reproduction unit control unit 34 to select reproduction data output from either the HDMI reception unit 31 or the reproduction unit wireless communication unit 33 so as to output the same, an OSD data generation unit 36 which generates OSD data based on an instruction from the reproduction unit control unit 34, a display adjustment unit 37 which adjusts a size of video data contained in the reproduction data output from the selector 35 and superimposes OSD data output from the OSD data generation unit 36 on the video data, a display panel 38 which displays the video data output from the display adjustment unit 37, a remote controller reception unit 39 which receives an instruction signal output from the remote controller 70 so as to output the same to the reproduction unit control unit 34, and a reproduction unit power supply unit 40 which is controlled by the reproduction unit control unit 34 so as to supply power for the operation of the reproduction unit 30.

In addition, the reproduction unit 30 further includes a reproduction unit power switching unit 41 which is controlled by the reproduction unit control unit 34 so as to switch whether or not the power for operation from the reproduction unit power supply unit 40 is to be supplied to the reproduction unit wireless communication unit 33, a locater signal modulation unit 42 which generates a locater signal based on a signal output from the reproduction unit control unit 34, a locater signal transmission antenna 43 which transmits the locater signal generated by the locater signal modulation unit 42, a timer 44 which is controlled by the reproduction unit control unit 34 so as to measure time, and a locater operation instruction unit 45 to which a user's instruction is input about whether or not informing operation of the remote controller 70 is necessary.

In addition, the remote controller 70 includes an informing unit 71 which receives the locater signal so as to perform the informing operation.

Note that the instruction signal output from the remote controller 70 may be an infrared signal, and the remote controller reception unit 39 is equipped with an infrared light receiving element. In addition, the reproduction unit 30 may have a configuration for reproducing sound data included in the reproduction data (e.g., a speaker or the like).

<Operations of Individual Units in Reproducing Operation of Reproducing Apparatus>

Next, operations of the individual units of the reproducing apparatus 1 illustrated in FIG. 1 will be described. First, operations of the individual units in the case where the signal processing unit 10 of the reproducing apparatus 1 and the power supply for the operation of the reproduction unit 30 are both turned on and the reproducing apparatus 1 performs the reproducing operation of the reproduction data will be described.

The reproducing apparatus 1 first receives a broadcasting signal with the broadcasting reception antenna 11 of the signal processing unit 10. The broadcasting signal received with the broadcasting reception antenna 11 is supplied to the tuner 12, which obtains a predetermined frequency component selectively and performs frequency conversion (down conversion), and the result is input to the decoder 13. The decoder 13 demodulates and decodes the signal supplied from the tuner 12 so as to generate the reproduction data. Note that here is exemplified a configuration where the broadcasting signal is received so that reproduction data is generated, but in addition to (or instead of) this configuration, it is possible to adopt a configuration where other means such as a network or a recording medium are used for obtaining the reproduction data.

The reproduction data generated by the decoder 13 is transmitted from the signal processing unit 10 to the reproduction unit 30 via either the HDMI cable 50 or the wireless communication.

If the reproduction data is transmitted via the HDMI cable 50, the reproduction data is transmitted from the HDMI transmission unit 14 to the reproduction unit 30 via the HDMI cable 50, so as to be received by the HDMI reception unit 31. In contrast, if the reproduction data is transmitted by wireless communication, the reproduction data is first encoded and modulated by the signal processing unit wireless communication unit 15, so that the wireless signal is generated. The generated wireless signal is transmitted from the signal processing unit antenna 16 to the reproduction unit 30 so as to be received by the reproduction unit antenna 32. Then, the received wireless signal is demodulated and decoded by the reproduction unit wireless communication unit 33 so that the reproduction data is generated.

The selector 35 obtains the reproduction data selectively from the HDMI reception unit 31 or the reproduction unit wireless communication unit 33 and outputs the same. Switching of the source of the reproduction data by the selector 35 is performed by the reproduction unit control unit 34. For instance, the reproduction unit control unit 34 checks a currently set transmission mode (an HDMI cable mode or a wireless communication mode) of the reproduction data so as to control and switch the selector 35.

The video data contained in the reproduction data output from the selector 35 is input to the display adjustment unit 37. The display adjustment unit 37 performs an interpolation process of pixels, an adding process, a thinning process and the like on the input video data, so as to convert it to have a size that can be displayed on the display panel 38 (scaling). In addition, when the OSD data is supplied from the OSD data generation unit 36, the display adjustment unit 37 superimposes the OSD data on the scaled video data. Then, the display panel 38 displays the video data supplied from the display adjustment unit 37.

<Operations of Individual Units in Starting of Reproducing Apparatus>

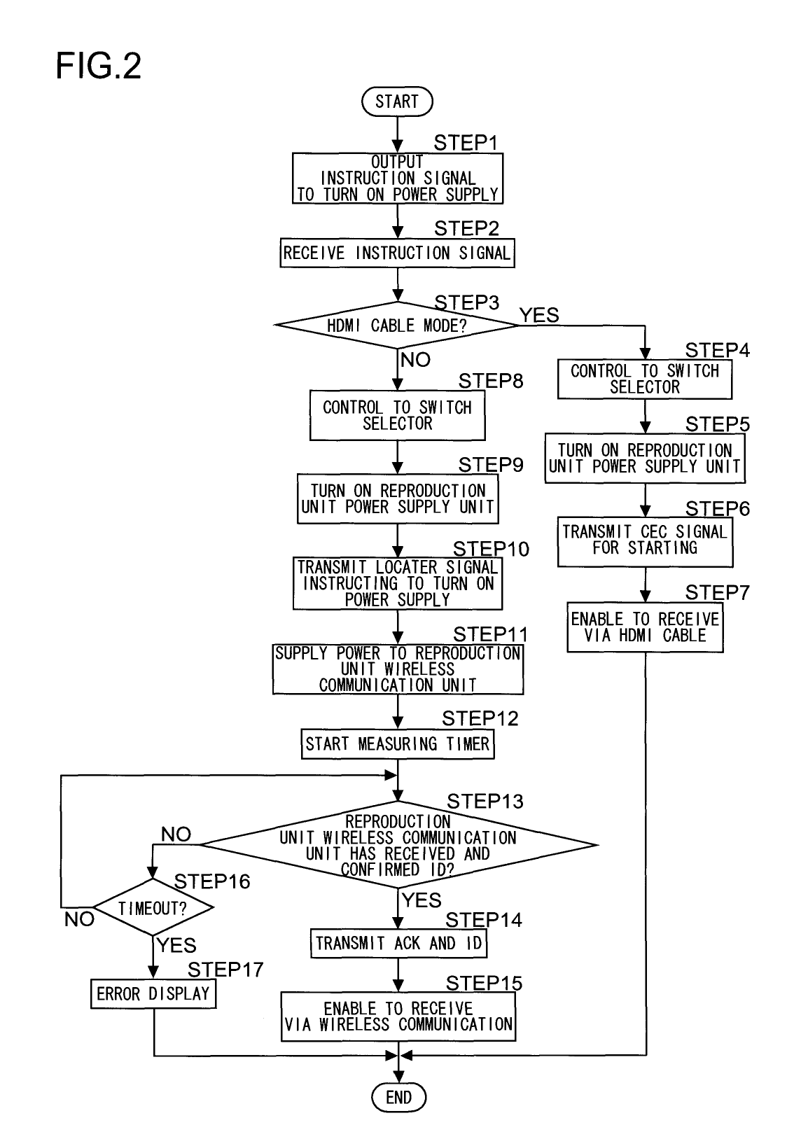

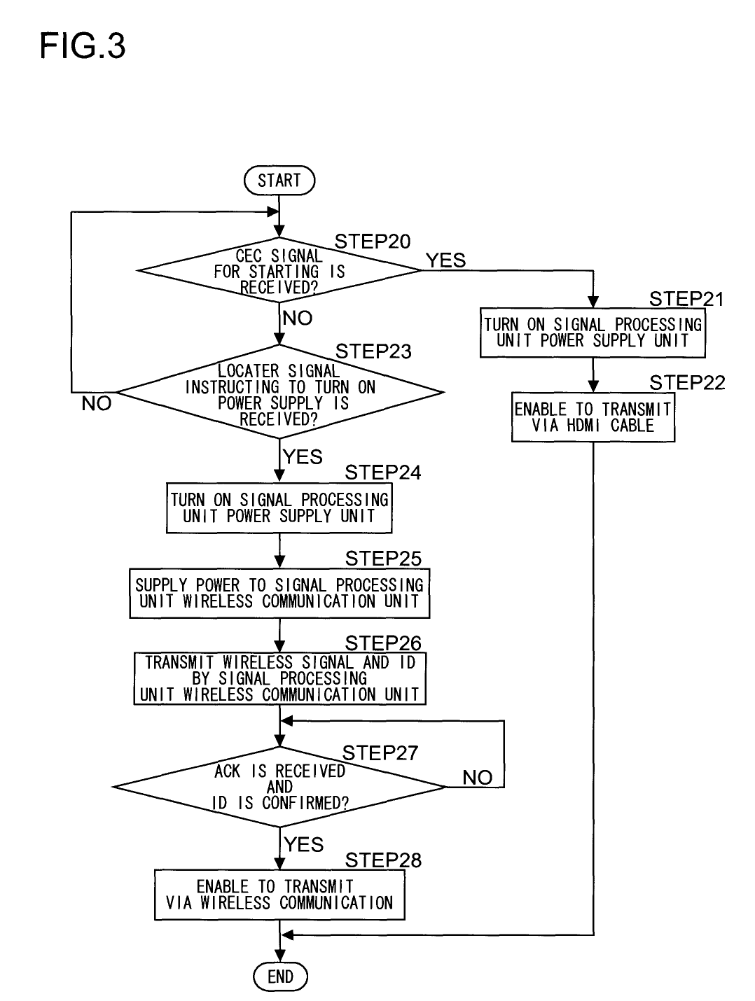

Next, operations of the individual units in starting will be described with reference to the drawings, in which the signal processing unit 10 of the reproducing apparatus 1 and the power supply for the operation of the reproduction unit 30 are both turned on so that the reproducing apparatus 1 becomes a state where the reproducing operation can be performed. FIGS. 2 and 3 are flowcharts illustrating an operation when the reproducing apparatus according to the embodiment of the present invention starts. Note that FIG. 2 illustrates the operation of the reproduction unit 30, and FIG. 3 illustrates the operation of the signal processing unit 10. In addition, a case of starting from the output of the instruction signal from the remote controller 70 will be described.

First, as illustrated in FIG. 2, when an instruction signal for starting the reproducing apparatus 1 (an instruction signal to turn on the power supply for the signal processing unit 10 and the operation of the reproduction unit 30 so as to set them to a state capable of performing generation, transmission and reproduction of the reproduction data) is output from the remote controller 70 operated by the user to the reproduction unit 30 (STEP 1), the remote controller reception unit 39 of the reproduction unit 30 receives the instruction signal (STEP 2), and transmits the same to the reproduction unit control unit 34. In this case, the reproduction unit power supply unit 40 which supplies power for operation to the individual units of the reproduction unit 30 is turned off, but at least the reproduction unit control unit 34, the remote controller reception unit 39 and the locater signal modulation unit 42 are supplied with power and are in the state capable of operating.

The reproduction unit control unit 34 confirms that the above-mentioned instruction signal is supplied to the remote controller reception unit 39, and then checks whether or not the transmission mode of the reproduction data is the HDMI cable mode (STEP 3).

If the transmission mode is the HDMI cable mode (YES in STEP 3), the reproduction unit control unit 34 controls to switch the selector 35 so as to obtain the reproduction data from the HDMI reception unit 31 (STEP 4) and turns on power supply for the operation of the reproduction unit power supply unit 40 (STEP 5). Further, a CEC signal for starting that indicates to turn on power supply for the operation of the signal processing unit 10 is transmitted to the signal processing unit 10 via the HDMI cable 50 (STEP 6). Then, the state capable of receiving the reproduction data transmitted via the HDMI cable 50 is set (STEP 7), and the operation in starting the reproduction unit 30 is finished.

In addition, as illustrated in FIG. 3, the signal processing unit 10 starts the operation in the start when the signal processing unit control unit 17 receives the CEC signal for starting that is transmitted in STEP 6 (see FIG. 2) (YES in STEP 20). In this case, similarly to the reproduction unit 30, the signal processing unit power supply unit 19 which supplies power for operation to the individual units of the signal processing unit 30 is turned off. However, at least the signal processing unit control unit 19 and the locater signal demodulation unit 22 are supplied with power and are in the state capable of operating.

When the signal processing unit control unit 17 confirms in STEP 20 that the above-mentioned CEC signal for starting is received, it turns on power supply for operation by the signal processing unit power supply unit 19 (STEP 21) and sets the state where the reproduction data can be transmitted via the HDMI cable 50 (STEP 22). Then, the operation when the signal processing unit 10 starts is finished.

On the other hand, if the transmission mode is not the HDMI cable mode but the wireless communication mode in STEP 3 of FIG. 2 (NO in STEP 3), the reproduction unit control unit 34 controls to switch the selector 35 so as to obtain the reproduction data from the reproduction unit wireless communication unit 33 (STEP 8) and turns on power supply for operation by the reproduction unit power supply unit 40 (STEP 9). Further, a predetermined signal is input to the locater signal modulation unit 42 so that the locater signal transmission antenna 43 transmits a locater signal for turning on power supply for the operation of the signal processing unit 10 (STEP 10).

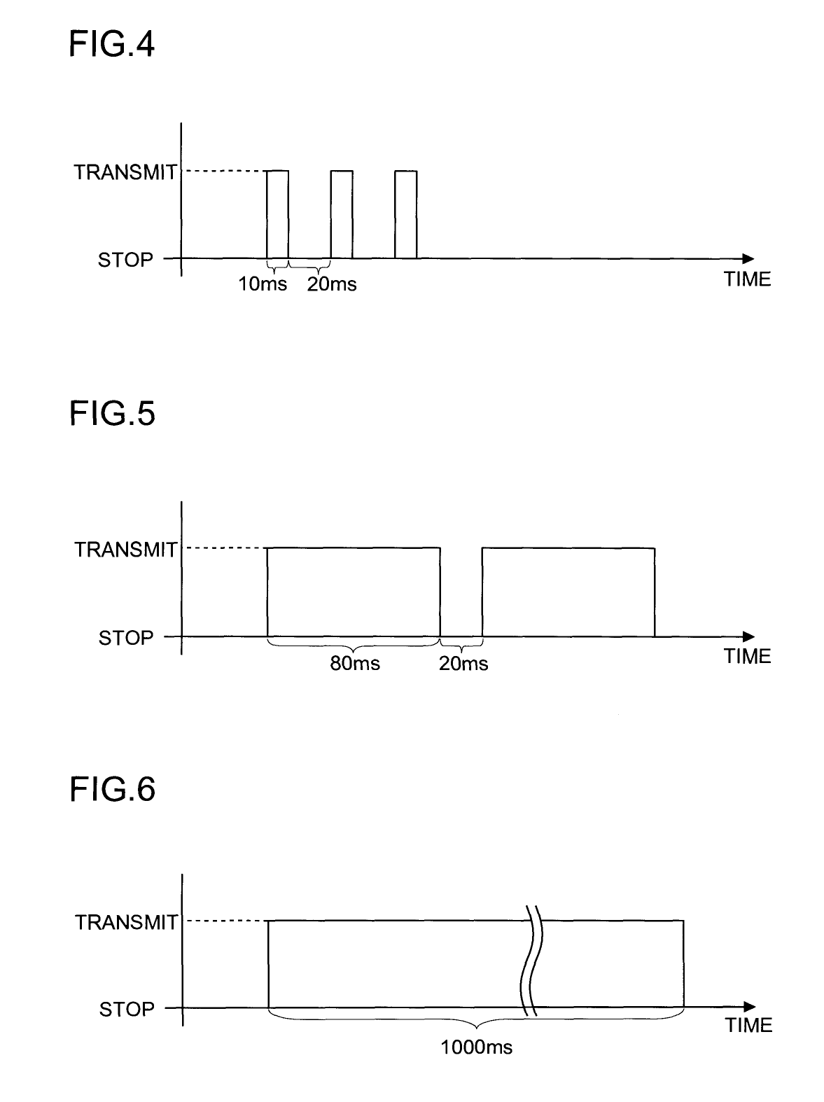

Here, an example of a pattern of the locater signal for turning on the power supply for the operation of the signal processing unit 10 will be described with reference to FIG. 4. FIG. 4 is a timing chart illustrating an example of the pattern of the locater signal for turning on the power supply for the operation of the signal processing unit. Note that FIG. 4 illustrates an example of a pattern in which a 10 ms pulse-like signal is transmitted three times so that a 20 ms stop period is formed between them.

In addition, the reproduction unit control unit 34 controls to switch the reproduction unit power switching unit 41 so as to supply power for operation to the reproduction unit wireless communication unit 33 (STEP 11). Then, the timer 44 is made to operate so as to start measuring time (STEP 12).

In addition, as illustrated in FIG. 3, the signal processing unit 10 starts an operation for starting when the locater signal demodulation unit 22 transmits to the signal processing unit control unit 17 that the locater signal transmitted in STEP 10 (see FIG. 2) is received via the locater signal reception antenna 21 (NO in STEP 20 and YES in STEP 23). In this case, as described above, at least the signal processing unit control unit 19 and the locater signal demodulation unit 22 are supplied with power and are in the state capable of operating.

When the signal processing unit control unit 17 confirms in STEP 23 that the above-mentioned locater signal is received, it turns on the signal processing unit power supply unit 19 (STEP 24), and controls to switch the signal processing unit power switching unit 20 so as to supply power for operation to the signal processing unit wireless communication unit 15 (STEP 25). In addition, it controls the signal processing unit wireless communication unit 15 so as to generate a wireless signal containing an ID code of the signal processing unit 10, and transmits the same to the reproduction unit 30 via the signal processing unit antenna 16 (STEP 26).

As illustrated in FIG. 2, the reproduction unit control unit 34 checks whether or not the wireless signal transmitted in STEP 26 (see FIG. 3) is received via the reproduction unit antenna 32 and the reproduction unit wireless communication unit 33 has obtained from the wireless signal a correct ID code (e.g., an ID code that matches the ID code of the signal processing unit 10 enrolled in advance) (STEP 13).

When the wireless signal is received and it is confirmed that the correct ID code is obtained (YES in STEP 13), the reproduction unit wireless communication unit 33 generates an ACK signal containing the ID code of the reproduction unit 30 and transmits the same to the signal processing unit 10 via the reproduction unit antenna 32 (STEP 14). Then, the state is set where the reproduction data transmitted via the wireless communication can be received (STEP 15), and the operation when the reproduction unit 30 is started is finished.

In addition, as illustrated in FIG. 3, the signal processing unit control unit 17 checks whether or not the ACK signal transmitted in STEP 14 (see FIG. 2) is received via the signal processing unit antenna 16, and the signal processing unit wireless communication unit 15 has obtained from the ACK signal the correct ID code (e.g., an ID code that matches the ID code of the reproduction unit 30 enrolled in advance) (STEP 27). If it is confirmed that the ACK signal is received and the correct ID code is obtained (YES in STEP 27), the state is set where the reproduction data can be transmitted via the wireless communication (STEP 28), and the operation when the signal processing unit 10 is started is finished.

On the other hand, in STEP 13 of FIG. 2, if the wireless signal is not received, or if the correct ID code is not obtained (NO in STEP 13) and the measured time of the timer 44 exceeds a predetermined time to be time out (YES in STEP 16), the reproduction unit control unit 34 inputs an instruction to the OSD data generation unit 36 to generate OSD data for an error display, so that the display panel 38 displays the error display (STEP 17). Then, the operation when the reproduction unit 30 is started is finished.

Note that when the error display is displayed in STEP 17, it is possible to display a message urging to operate the power supply operating unit 18 to turn on the signal processing unit 10. With this structure, it is possible to appeal the user to activate the signal processing unit 10 manually in the case where the signal processing unit 10 cannot be activated due to a communication trouble caused by the locater signal. In addition, even if the user activate the signal processing unit 10 manually, it is possible to confirm the ID code as in STEP 13 of FIG. 2 or in STEP 27 of FIG. 3 (see STEP 13 to STEP 15 in FIG. 2 and STEP 26 to STEP 28 in FIG. 3).

In addition, the above-mentioned operation is the operation when the reproducing apparatus 1 is started, but it is possible to perform the same operation when it is finished (when power supply for the signal processing unit 10 and the operation of the reproduction unit 30 is turned off). Specifically, for example, when the remote controller 70 inputs the instruction signal to the reproduction unit 30 to turn off the reproducing apparatus 1, power supply for the operation of the signal processing unit 10 is turned off by the CEC signal for finishing in the HDMI cable mode. In contrast, in the wireless communication mode, power supply for the operation of the signal processing unit 10 is turned off by the locater signal.

However, when the signal processing unit 10 is turned off by the locater signal in the wireless communication mode, it is preferable that the pattern of the locater signal is different from the pattern for turning off power supply for the operation of the signal processing unit illustrated in FIG. 4. A specific example of the pattern will be described with reference to FIG. 5. FIG. 5 is a timing chart illustrating an example of the pattern of the locater signal for turning off the power supply for the operation of the signal processing unit. Note that FIG. 5 exemplifies a pattern in which an 80 ms signal is transmitted two times so that a 20 ms stop period is formed between them.

<Operations of Individual Units in Informing Operation of Remote Controller>

Next, operations of the individual units in the case where the remote controller 70 performs an informing operation will be described. The informing operation of the remote controller 70 means an operation that can be performed when the user lost sight of the remote controller 70. For instance, the remote controller 70 generates sound, vibration, light or the like, so that the user is informed of the location of the remote controller 70. Note that the above description describes the structure in which the locater signal is used for controlling on and off of the signal processing unit 10, but it is possible that the original use of the locater signal is for the remote controller 70 to perform the informing operation.

When the user input the instruction for the remote controller 70 to perform the informing operation to the locater operation instruction unit 45, the locater operation instruction unit 45 outputs a signal indicating the same to the reproduction unit control unit 34. Thus, the reproduction unit control unit 34 inputs a signal of a predetermined pattern to the locater signal modulation unit 42. The locater signal modulation unit 42 generates the locater signal based on the signal input from the reproduction unit control unit 34 and transmits the same via the locater signal transmission antenna 43. The informing unit 71 of the remote controller 70 receives the transmitted locater signal so as to perform the informing operation.

However, it is preferable that the pattern of the locater signal for the remote controller 70 to perform the informing operation is different from the pattern for turning on or off power supply for the operation of the signal processing unit 10 illustrated in FIG. 4 or 5. A specific example of the pattern will be described with reference to FIG. 6. FIG. 6 is a timing chart illustrating an example of the pattern of the locater signal for the remote controller to perform the informing operation. FIG. 6 illustrates an example of a pattern in which the locater signal is transmitted continuously for 1000 ms.

With the above-mentioned configuration, the remote controller reception unit 39 is disposed only in the reproduction unit 30, and a common remote controller 70 is provided for transmitting instruction signals to the signal processing unit 10 and the reproduction unit 30. Still in this case, utilizing the locater signal, the content of the instruction signal input to the reproduction unit 30 from the remote controller 70 can be transmitted to the signal processing unit 10 so as to operate the signal processing unit 10.

In particular, when power supply for the operation of the signal processing unit 10 is turned off, it is possible to eliminate necessity of always supplying power for operation to the signal processing unit wireless communication unit 15 and the reproduction unit wireless communication unit 33 remote controller 70 so as to respond the case where the instruction signal to turn on power supply for the operation of the signal processing unit 10 is input to the reproduction unit 30. Therefore, power consumption of the reproducing apparatus 1 can be suppressed.

Further, it is possible to control the operation of the signal processing unit 10 by using the locater signal that is used for the informing operation of the remote controller 70. Therefore, only by adding a structure for receiving the locater signal to the signal processing unit 10, it is possible to realize the configuration of the reproducing apparatus 1 easily without a substantial modification in design.

<Variations>

Note that the remote controller reception unit 39 is disposed in the reproduction unit 30 in the above description, so that the locater signal is transmitted from the reproduction unit 30 to the signal processing unit 10, but it is possible to adopt the opposite configuration. Specifically, the remote controller reception unit 39 may be disposed in the signal processing unit 10, and the locater signal may be transmitted from the signal processing unit 10 to the reproduction unit 30. In this case, the reproduction unit 30 performs the operation based on the received locater signal.

In addition, it is possible to adopt a structure in which the locater signal is a frequency modulation (FM) signal, the locater signal modulation unit 42 includes an FM modulation circuit, and the locater signal demodulation unit 22 and the informing unit 71 include an FM demodulation circuit. With this structure, a circuit configuration can be simplified and power consumption can be reduced. Note that it is possible to adopt another structure (e.g., a structure using an amplitude modulation (AM) signal) as long as it is simple and can reduce power consumption. In addition, a constant signal is transmitted in a transmission period in the description with reference to FIGS. 4 to 6, but it is possible to adopt a structure in which different signals (frequencies, amplitudes and the like) are transmitted. In addition, for example, it is possible to adopt a structure in which the different signals are output between the transmission period and the stop period.

In addition, it is possible to adopt a structure in which the wireless signal is an orthogonal frequency division multiplexing (OFDM) signal. With this structure, the reproduction data such as a moving image to be a large quantity can be transmitted efficiently and stably. Note that it is possible to adopt other signal format as long as it can transmit a large quantity of data.

In addition, operations of the signal processing unit control unit 17, the reproduction unit control unit 34 and the like disposed in the reproducing apparatus 1 of the embodiment of the present invention may be performed by a control unit such as a microprocessor or a sub microprocessor (a microprocessor performing auxiliary control). Further, a whole or a part of functions realized by the control unit may be described as a program, so that a program execution device (e.g., a computer) executes the program for realizing the whole or the part of functions.

In addition, without limiting to the above-mentioned case, the reproducing apparatus 1 illustrated in FIG. 1 can be realized by hardware or a combination of hardware and software. In addition, if a part of the reproducing apparatus 1 is constituted by using software, the block diagram of the part realized by software represents a functional block diagram of the part.

Although the embodiment of the present invention is described above, the scope of the present invention is not limited to the embodiment, which can be modified variously within the scope of the present invention without deviating from the spirit thereof

The present invention is related to a reproducing apparatus including a signal processing unit such as a STB which generates and transmits reproduction data by receiving a broadcasting signal or the like, and a reproduction unit such as a display device which receives and reproduces the reproduction data.

FIG. 1

10 signal processing unit

30 reproduction unit

12 tuner

13 decoder

14 HDMI transmission unit

50 HDMI cable

31 HDMI reception unit

35 selector

37 display adjustment unit

38 display panel

36 OSD data generation unit

15 signal processing unit wireless communication unit

wireless signal

33 reproduction unit wireless communication unit

34 reproduction unit control unit

45 locater operation instruction unit

18 power supply operating unit

17 signal processing unit control unit

19 signal processing unit power supply unit

40 reproduction unit power supply unit

22 locater signal demodulation unit

locater signal

42 locater signal modulation unit

44 timer

39 remote controller reception unit

70 remote controller

71 informing unit

instruction signal

FIG. 2

start

STEP 1 output instruction signal to turn on power supply

STEP 2 receive instruction signal

STEP 3 HDMI cable mode?

STEP 4 control to switch selector

STEP 5 turn on reproduction unit power supply unit

STEP 6 transmit CEC signal for starting

STEP 10 transmit locater signal instructing to turn on power supply

STEP 7 enable to receive via HDMI cable

STEP 11 supply power to reproduction unit wireless communication unit

STEP 12 start measuring timer

STEP 13 reproduction unit wireless communication unit has received and confirmed ID?

STEP 16 timeout?

STEP 14 transmit ACK and ID

STEP 17 error display

STEP 15 enable to receive via wireless communication

end

FIG. 3

STEP 20 CEC signal for starting is received?

STEP 21 turn on signal processing unit power supply unit

STEP 23 locater signal instructing to turn on power supply is received?

STEP 22 enable to transmit via HDMI cable

STEP 24 turn on signal processing unit power supply unit

STEP 25 supply power to signal processing unit wireless communication unit

STEP 26 transmit wireless signal and ID by signal processing unit wireless communication unit

STEP 27 ACK is received and ID is confirmed?

STEP 28 enable to transmit via wireless communication

FIG. 4

transmit

stop

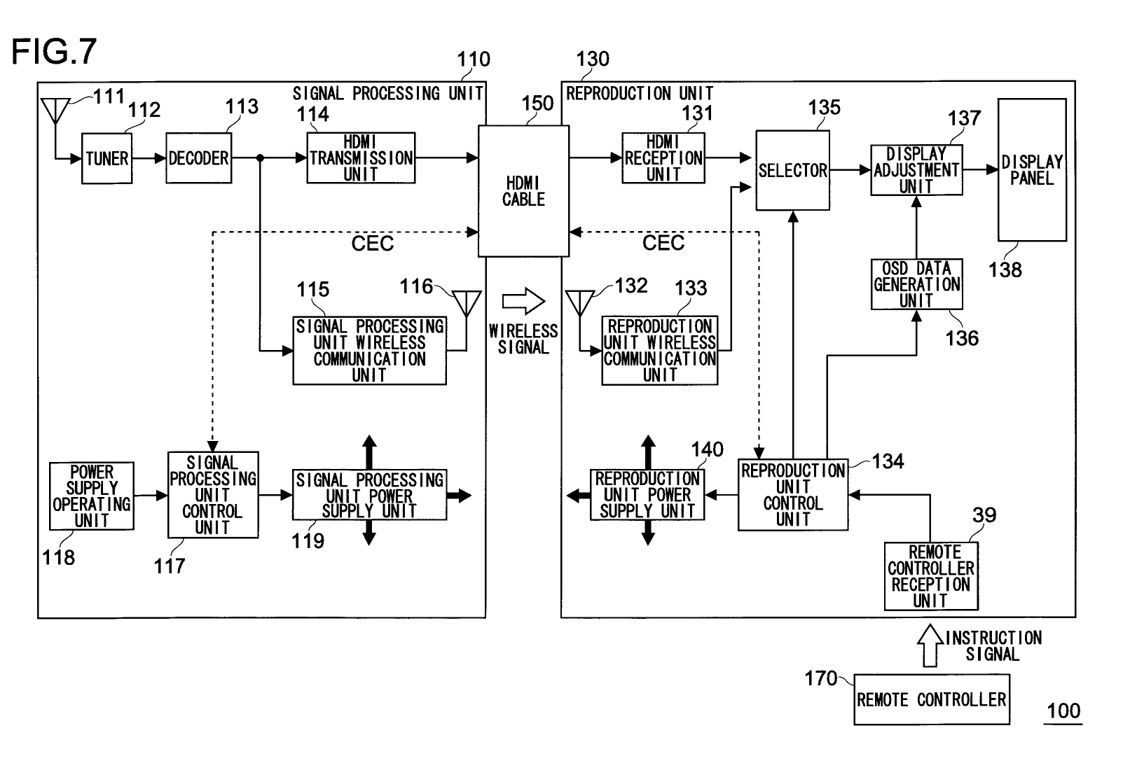

FIG. 7 (see FIG. 1)

What is claimed is:

1. A reproducing apparatus comprising:
a signal processing unit which generates reproduction data;
a reproduction unit which reproduces the reproduction data;
a first wireless communication unit which performs wireless transmission of a wireless signal containing the reproduction data from the signal processing unit to the reproduction unit; and
a second wireless communication unit which performs wireless transmission of a control signal from one of the reproduction unit and the signal processing unit to the other, wherein
the reproduction unit or the signal processing unit operates based on the control signal that is received.

2. A reproducing apparatus according to claim 1, further comprising an instruction transmission unit which performs wireless transmission of an instruction signal to instruct operation of at least one of the signal processing unit and the reproduction unit, wherein
the reproduction unit includes a reception unit which receives the instruction signal transmitted via wireless from the instruction transmission unit, and
the second wireless communication unit performs wireless transmission of the control signal from the reproduction unit to the signal processing unit, so that the signal processing unit operates based on the control signal that is received.

3. A reproducing apparatus according to claim 2, wherein the reproduction unit controls to enable or disable power supply for operation based on the instruction signal, and the signal processing unit controls to enable or disable power supply for operation based on the control signal.

4. A reproducing apparatus according to claim 2, wherein the instruction transmission unit includes an informing unit which receives the control signal to be a predetermined pattern so as to perform an informing operation.

5. A reproducing apparatus according to claim 2, wherein when the second wireless communication unit is disabled to communicate, the reproduction unit performs a predetermined reproducing operation.

6. A reproducing apparatus according to claim 5, wherein if the reproduction unit cannot receive a predetermined signal from the signal processing unit via the first wireless communication unit before a predetermined time passes after the control signal is transmitted to the signal processing unit via the second wireless communication unit, it is decided that the second wireless communication unit is disabled to communicate.
